(19) United States
(12) Patent Application Publication
(10) Pub. No.: US 2026/0018650 A1
(43) Pub. Date: Jan. 15, 2026

(54) METHOD AND APPARATUS FOR PREPARING ELECTRODE SHEET, ELECTRODE SHEET, AND BATTERY CELL

(71) Applicant: LEOCH INTERNATIONAL HOLDING PTE. LTD., SINGAPORE (SG)

(72) Inventors: Xianbao CHEN, SINGAPORE (SG); Chunxiang MA, SINGAPORE (SG); Jie DONG, SINGAPORE (SG); Zhenyu ZHUO, SINGAPORE (SG); Bingbing ZHANG, SINGAPORE (SG)

(21) Appl. No.: 19/333,405

(22) Filed: Sep. 19, 2025

Related U.S. Application Data
(63) Continuation of application No. PCT/CN2024/127667, filed on Oct. 28, 2024.

(30) Foreign Application Priority Data
Mar. 29, 2024 (CN) 202410375915.4

(51) Int. Cl. H01M 10/04

(52) U.S. Cl. CPC H01M 10/0413; H01M 10/0468

(57) ABSTRACT

Provided are a method for preparing an electrode sheet, an apparatus for preparing an electrode sheet, an electrode sheet, and a battery cell. The method for preparing the electrode sheet includes: cutting a dry-process electrode film material to form a dry-process electrode film; cutting a current collector material to form a current collector, a size of the current collector being smaller than or equal to that of the dry-process electrode film; and sequentially stacking and pressing a plurality of layers of dry-process electrode films, the current collector, and a plurality of layers of dry-process electrode films to form the electrode sheet, the plurality of layers of dry-process electrode films on a same side of the current collector are arranged in a manner that front and back sides of the plurality of layers of dry-process electrode films alternate with respect to the current collector.

### CROSS-REFERENCE TO RELATED APPLICATION

This application is a continuation of International Application No. PCT/CN2024/127667, filed on Oct. 28, 2024, which is based on and claims priority to Chinese patent application No. 202410375915.4 filed on Mar. 29, 2024, the entire contents of which are incorporated herein by reference.

### FIELD

The present disclosure relates to the field of battery technologies, and more particularly, to a method and an apparatus for preparing an electrode sheet, an electrode sheet, a battery cell, and a battery device.

### BACKGROUND

In recent years, a new dry-process electrode manufacturing technology has emerged. An electrode film is prepared by a solvent-free method and then bonded to a current collector to form an electrode, which is environmentally friendly and does not require evaporation of a solvent, greatly reducing costs. Moreover, no solvent is used during a manufacturing process of a dry-process electrode. A binder exists in a fiber state or a sheet form without affecting internal contact between active material particles. The electrode has good conductivity, high capacity and good rate performance.

However, at present, the dry-process electrode film is substantially bonded directly to a current collector by rolling to obtain an electrode roll. Due to an uneven thickness of the dry-process electrode film, it can be seen from FIG. 1 that of the electrode roll may have an uneven thickness. During pressing and molding, there may be uneven extension, as well as obvious depression, bulging, and other deformations. In addition, in a general manufacturing process of a laminated battery, the electrode roll needs to be slit and stacked. During slitting, burrs are prone to appear on an aluminum foil or a copper foil, which may affect safety performance of a lithium-ion battery.

### SUMMARY

The present disclosure aims to solve at least one of the technical problems in the related art to some extent.

To this end, an objective of the present disclosure is to provide a method for preparing an electrode sheet, which can improve flatness of the electrode sheet after lamination and molding, and reduce a risk of defects such as burrs in the electrode sheet, improving safety performance of a battery cell.

The present disclosure further provides an apparatus for preparing an electrode sheet.

The present disclosure further provides an electrode sheet.

The present disclosure further provides a battery cell.

The present disclosure further provides a battery device.

The method for preparing the electrode sheet according to the embodiment of the present disclosure includes: cutting a dry-process electrode film material to form a dry-process electrode film; cutting a current collector material to form a current collector, a size of the current collector being smaller than or equal to that of the dry-process electrode film; and sequentially stacking and pressing a plurality of layers of dry-process electrode films, the current collector, and a plurality of layers of dry-process electrode films to form the electrode sheet, the plurality of layers of dry-process electrode films on a same side of the current collector being arranged in a manner that front and back sides of the plurality of layers of dry-process electrode films alternate with respect to the current collector.

With the method for preparing the electrode sheet according to the embodiment of the present disclosure, by arranging the plurality of layers of dry-process electrode films in a manner that front and back sides of the plurality of layers of dry-process electrode films alternate with respect to the current collector, a risk of the electrode sheet having an uneven thickness can be reduced, improving the flatness of the electrode sheet after lamination and molding, and also reducing the risk of defects such as burrs in the electrode sheet. Therefore, the safety performance of the battery cell can be improved.

The apparatus for preparing the electrode sheet according to the embodiment of the present disclosure includes: a fixation support provided with a linear module at a top wall of the fixation support, the linear module having a moving block movable in a first direction; a laminator disposed in the fixation support, the laminator including a laminator body movably disposed at a bottom wall of the fixation support and a pressing head disposed at the top wall of the fixation support, the pressing head being located at a side of the linear module in a second direction, the laminator body being selectively movable to a position below the pressing head, and the first direction, the second direction, and a height direction of the apparatus for preparing the electrode sheet being mutually perpendicular; two placement tables disposed in the fixation support and at the bottom wall of the fixation support in the first direction, the two placement tables being disposed at two sides of the laminator body, respectively; and a material suction assembly connected to the moving block, the material suction assembly being driven to move when the moving block moves, the material suction assembly including two suction structures arranged in the first direction and configured to selectively pick the dry-process electrode film of the electrode sheet, the two suction structures being liftable in the height direction of the apparatus for preparing the electrode sheet.

With the apparatus for preparing the electrode sheet according to the embodiment of the present disclosure, by disposing the two placement tables at two sides of the laminator body, respectively, and placing the dry-process electrode films on the two placement tables in opposite directions, the two suction structures can sequentially pick the dry-process electrode films on the corresponding placement tables, and stack the dry-process electrode films on the corresponding placement tables on the current collector in sequence. In this way, the plurality of layers of dry-process electrode films can be arranged in a manner that front and back sides of the plurality of layers of dry-process electrode films alternate with respect to the current collector, reducing the risk of the electrode sheet having the uneven thickness, and thus improving the flatness of the electrode sheet after lamination and molding. Also, the risk of defects such as burrs in the electrode sheet can be reduced. Therefore, the safety performance of the battery cell can be improved.

The electrode sheet according to an embodiment of the present disclosure is prepared by the method for preparing the electrode sheet according to the above embodiments. The electrode sheet includes a current collector and a plurality of layers of dry-process electrode films. The current collector and the plurality of layers of dry-process electrode films are stacked together. The current collector has a first side and a second side opposite to the first side. The plurality of layers of dry-process electrode films are disposed on each of the first side and the second side. The plurality of layers of dry-process electrode films on a same side of the current collector are arranged in a manner that front and back sides of the plurality of layers of dry-process electrode films alternate with respect to the current collector.

With the electrode sheet according to the embodiment of the present disclosure, the current collector and the plurality of layers of dry-process electrode films are stacked together. The current collector has the first side and the second side opposite to the first side in a thickness direction of the current collector. The plurality of layers of dry-process electrode films are disposed on each of the first side and the second side. In addition, the plurality of layers of dry-process electrode films on the same side of the current collector are arranged in a manner that front and back sides of the plurality of layers of dry-process electrode films alternate with respect to the current collector, reducing the risk of the electrode sheet having the uneven thickness, and thus improving the flatness of the electrode sheet after lamination and molding. Also, the risk of defects such as burrs in the electrode sheet can be reduced.

The battery cell according to the embodiment of the present disclosure includes the electrode sheet according to the above embodiments.

With the battery cell according to the embodiment of the present disclosure, by disposing the two placement tables at the two sides of the laminator body, respectively, and placing the dry-process electrode films on the two placement tables in opposite directions, the two suction structures can sequentially pick the dry-process electrode films on the corresponding placement tables, and stack the dry-process electrode films on the corresponding placement tables on the current collector in sequence. In this way, the plurality of layers of dry-process electrode films can be arranged with in a manner that front and back sides of the plurality of layers of dry-process electrode films alternate with respect to the current collector, reducing the risk of the electrode sheet having the uneven thickness, and thus improving the flatness of the electrode sheet after lamination and molding. Also, the risk of defects such as burrs in the electrode sheet can be reduced. Therefore, the safety performance of the battery cell can be improved.

The battery device according to the embodiment of the present disclosure includes the battery cell according to the above embodiments.

With the battery device according to the embodiment of the present disclosure, by disposing the two placement tables at the two sides of the laminator body, respectively, and placing the dry-process electrode films on the two placement tables in opposite directions, the two suction structures can sequentially pick the dry-process electrode films on the corresponding placement tables, and stack the dry-process electrode films on the corresponding placement tables on the current collector in sequence. In this way, the plurality of layers of dry-process electrode films can be arranged in a manner that front and back sides of the plurality of layers of dry-process electrode films alternate with respect to the current collector, reducing the risk of the electrode sheet having the uneven thickness, and thus improving the flatness of the electrode sheet after lamination and molding. Also, the risk of defects such as burrs in the electrode sheet can be reduced, improving the safety performance of the battery cell. Therefore, safety performance of the battery device can be improved.

Additional aspects and advantages of the present disclosure will be provided at least in part in the following description, or will become apparent at least in part from the following description, or can be learned from practicing of the present disclosure.

### BRIEF DESCRIPTION OF THE DRAWINGS

FIG. 1 is a schematic structural view of a dry-process electrode film stacking structure in the related art.

FIG. 2 is a flowchart illustrating preparation of an electrode sheet by a method for preparing an electrode sheet according to an embodiment of the present disclosure.

FIG. 3 is a schematic structural view of an apparatus for preparing an electrode sheet according to an embodiment of the present disclosure.

FIG. 4 is a bottom view of a fixation support according to an embodiment of the present disclosure.

FIG. 5 is a schematic structural view of a material suction assembly according to an embodiment of the present disclosure.

FIG. 6 is a partial enlarged view of a material suction assembly according to an embodiment of the present disclosure.

FIG. 7 is a schematic structural view of a laminator according to an embodiment of the present disclosure.

FIG. 8 is a top view of a laminator body according to an embodiment of the present disclosure.

FIG. 9 is a schematic view showing a stacking sequence of a current collector and dry-process electrode films at two sides of the current collector according to an embodiment of the present disclosure.

### DETAILED DESCRIPTION

Embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative only, and are intended to explain, rather than limiting, the embodiments of the present disclosure.

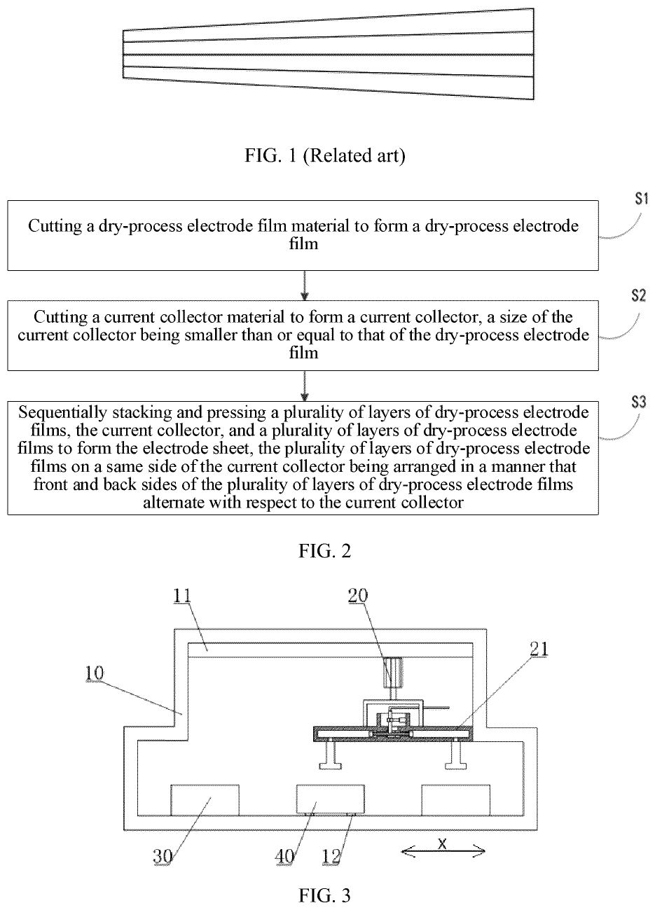

An apparatus for preparing an electrode sheet according to the embodiments of the present disclosure is described below with reference to FIG. 2 to FIG. 9.

As illustrated in FIG. 2, a method for preparing an electrode sheet is provided according to the embodiment of the present disclosure. The method includes following operations at blocks.

At S1, a dry-process electrode film material is cut to form a dry-process electrode film.

The dry-process electrode film material is cut so that a shape and a size of the dry-process electrode film are adapted to a shape and a size of the electrode sheet. It should be noted that the dry-process electrode film includes a positive dry-process electrode film and a negative dry-process electrode film.

At S2, a current collector material is cut to form a current collector. A size of the current collector is smaller than or equal to that of the dry-process electrode film.

As some embodiments of the present disclosure, the current collector material may be configured as an aluminum foil. As some embodiments of the present disclosure, the current collector material may be configured as a copper foil. The current collector material is cut so that a shape and the size of the current collector are adapted to the shape and the size of the electrode sheet. It should be noted that the size of the current collector is adapted to the size of the dry-process electrode film. As some embodiments of the present disclosure, the size of the current collector is smaller than that of the dry-process electrode film. As some embodiments of the present disclosure, the size of the current collector is equal to that of the dry-process electrode film, so that the dry-process electrode film and the current collector can be smoothly pressed to form the electrode sheet, and the dry-process electrode film can wrap the current collector.

At S3, a plurality of layers of dry-process electrode films, the current collector, and a plurality of layers of dry-process electrode films are sequentially stacked and pressed to form the electrode sheet. The plurality of layers of dry-process electrode films on a same side of the current collector are arranged in a manner that front and back sides of the plurality of layers of dry-process electrode films alternate with respect to the current collector.

The plurality of layers of dry-process electrode films, the current collector, and the plurality of layers of dry-process electrode films are stacked in sequence. In addition, in a thickness direction of the current collector, the plurality of layers of dry-process electrode films on one side of the current collector are arranged in a manner that front and back sides of the plurality of layers of dry-process electrode films alternate with respect to the current collector, and the plurality of layers of dry-process electrode films on the other side of the current collector are also arranged in a manner that front and back sides of the plurality of layers of dry-process electrode films alternate with respect to the current collector. As some embodiments of the present disclosure, the plurality of layers of dry-process electrode films, the current collector, and the plurality of layers of dry-process electrode films, which are stacked together, may be pressed by a laminator to form the electrode sheet.

It should be noted that a positive electrode sheet is formed by pressing the positive dry-process electrode film, and a negative electrode sheet is formed by pressing the negative electrode dry-process electrode film. In the thickness direction of the current collector, the plurality of layers of dry-process electrode films on two sides of the current collector may wrap an edge of the current collector to reduce a risk of burrs on the electrode sheet.

In an exemplary embodiment of the present disclosure, the dry-process electrode film material is cut so that the shape and the size of the dry-process electrode film are adapted to the shape and the size of the electrode sheet. It should be noted that the dry-process electrode film includes the positive dry-process electrode film and the negative dry-process electrode film. The current collector material is cut so that the shape and the size of the current collector are adapted to the shape and the size of the electrode sheet. It should be noted that the size of the current collector is adapted to the size of the dry-process electrode film. As some embodiments of the present disclosure, the size of the current collector is smaller than that of the dry-process electrode film. As some embodiments of the present disclosure, the size of the current collector is equal to that of the dry-process electrode film, so that the dry-process electrode film and the current collector can be smoothly pressed to form the electrode sheet.

As some embodiments of the present disclosure, the current collector may include a positive current collector and a negative current collector. Preparation of the positive electrode sheet may be completed by stacking the plurality of layers of positive dry-process electrode films arranged in a manner that their front and back sides alternate, the positive current collector, and another plurality of layers of positive dry-process electrode films arranged in a manner that their front and back sides alternate, and pressing the positive dry-process electrode films and the positive current collector that are stacked together.

Preparation of the negative electrode sheet may be completed by stacking the plurality of layers of negative dry-process electrode films arranged in a manner that their front and back sides alternate, the negative current collector, and another plurality of layers of negative dry-process electrode films arranged in a manner that their front and back sides alternate, and pressing the negative dry-process electrode films and the negative current collector that are stacked together.

The plurality of layers of dry-process electrode films, the current collector, and the plurality of layers of dry-process electrode films are stacked in sequence. In addition, in the thickness direction of the current collector, the plurality of layers of dry-process electrode films on one side of the current collector are arranged in a manner that front and back sides of the plurality of layers of dry-process electrode films alternate with respect to the current collector, and the plurality of layers of dry-process electrode films on the other side of the current collector are also arranged in a manner that front and back sides of the plurality of layers of dry-process electrode films alternate with respect to the current collector. As some embodiments of the present disclosure, the plurality of layers of dry-process electrode films, the current collector, and the plurality of layers of dry-process electrode films, which are stacked together, may be pressed by the laminator to form the electrode sheet.

By enabling the dry-process electrode films on the same side of the current collector to be sequentially arranged in a manner that front and back sides of the plurality of layers of dry-process electrode films alternate, the uneven thickness of the electrode film in a pressing process can be eliminated, improving safety performance of the electrode sheet. The size of the plurality of layers of electrode films is greater than or equal to the size of the current collector. During laminating, a first electrode film layer or a second electrode film layer may uniformly deform and extend towards an edge to wrap a cut edge of the current collector, which can eliminate an influence of burrs. In addition, stacking the electrode films in a manner that front and back sides of the electrode films alternate can effectively reduce a risk of local areas being too thick or too thin caused by stacking all electrode films with only front sides or back sides facing up, improving flatness of the electrode sheet.

Therefore, with the method for preparing the electrode sheet according to the present disclosure, by arranging the plurality of layers of dry-process electrode films in a manner that front and back sides of the plurality of layers of dry-process electrode films alternate with respect to the current collector, a risk of the electrode sheet having an uneven thickness can be reduced, improving the flatness of the electrode sheet after lamination and molding, and also reducing a risk of defects such as burrs in the electrode sheet. Therefore, safety performance of the battery cell can be improved.

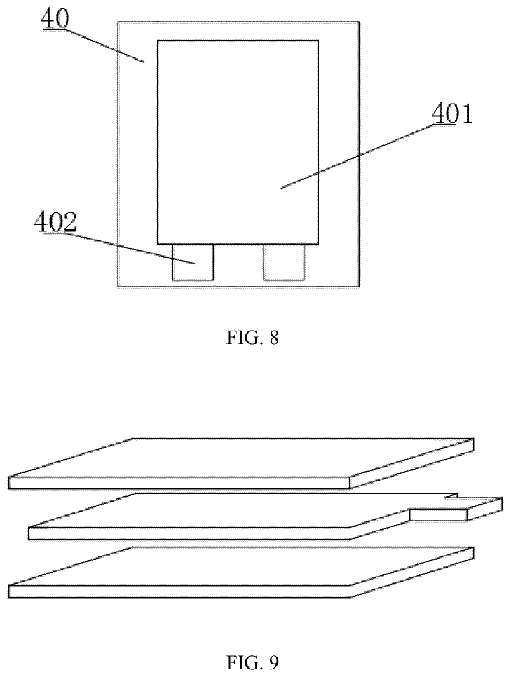

In some embodiments of the present disclosure, as illustrated in FIG. 9, the current collector is provided with an electrode tab.

The electrode tab is an important interface connecting an internal current collector of the battery cell and an external circuit. By disposing the electrode tab on the current collector, a current generated by the battery cell may be conducted to the external circuit by the electrode tab.

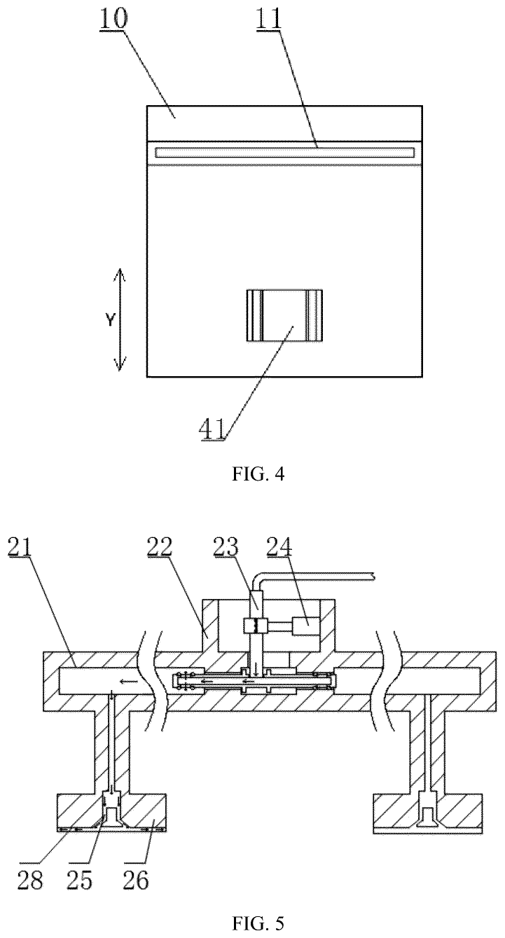

As illustrated in FIG. 3 to FIG. 6, an apparatus for preparing the electrode sheet according to an embodiment of the present disclosure is shown, the electrode sheet is prepared by the method for preparing the electrode sheet in the above embodiments using the apparatus for preparing the electrode sheet. The apparatus for preparing the electrode sheet includes a fixation support 10, a laminator disposed in the fixation support 10, two placement tables 30, and a material suction assembly. The fixation support 10 is provided with a linear module 11 at a top wall of the fixation support 10. The linear module 11 has a moving block movable in a first direction. The laminator includes a laminator body 40 movably disposed at a bottom wall of the fixation support 10 and a pressing head 41 disposed at the top wall of the fixation support 10. The pressing head 41 is located at a side of the linear module 11 in a second direction. The laminator body 40 is selectively movable to a position below the pressing head 41. The first direction, the second direction, and a height direction of the apparatus for preparing the electrode sheet are mutually perpendicular. The two placement tables 30 are disposed in the fixation support 10 and at the bottom wall of the fixation support 10 in the first direction. The two placement tables 30 are disposed at two sides of the laminator body 40, respectively. The material suction assembly is connected to the moving block. The material suction assembly is driven to move with a movement of the moving block. The material suction assembly includes two suction structures arranged in the first direction and configured to selectively pick the dry-process electrode film of the electrode sheet. The two suction structures are liftable in the height direction of the apparatus for preparing the electrode sheet.

In the height direction of the apparatus for preparing the electrode sheet, the fixation support 10 is provided with the linear module 11 at the top wall of the fixation support 10. The linear module 11 has the moving block. The moving block may reciprocate in the first direction, that is, an X direction in FIG. 1. The first direction is perpendicular to the height direction of the apparatus for preparing the electrode sheet. The laminator includes the laminator body 40 and the pressing head 41. The laminator body 40 is configured for placement of the dry-process electrode film and the current collector that are stacked together. The pressing head 41 is configured to press the stacked dry-process electrode films and the current collector that are located on the laminator body 40 to form the electrode sheet. Both the laminated body 40 and the pressing head 41 are disposed in the fixation support 10. The laminator body 40 is movably disposed at the bottom wall of the fixation support 10. As some embodiments of the present disclosure, the laminator body 40 may be movably disposed at the bottom wall of the fixation support 10 through a sliding rail, a conveyor belt, or the like, but is not limited thereto, to enable the laminator body 40 to be freely moved to a suitable position at the bottom wall of the fixation support 10.

The pressing head 41 may be disposed at the top wall of the fixation support 10 through bolting, welding, or the like, but is not limited thereto. The second direction is perpendicular to each of the first direction and the height direction of the apparatus for preparing the electrode sheet. In the second direction, that is, a Y direction in FIG. 2, the pressing head 41 is located at the side of the linear module 11, reducing a risk of interference with the pressing head 41 when the linear module 11 is in operation. In the height direction of the apparatus for preparing the electrode sheet, the laminator body 40 is selectively movable to a position below the pressing head 41, to enable the pressing head 41 to smoothly press the stacked dry process electrode film and the current collector that are located on the laminator body 40 to form the electrode sheet.

The placement table 30 is configured for placement of the dry-process electrode film. The two placement tables 30 are disposed in the fixation support 10 and may be connected to the bottom wall of the fixation support 10 through bolting, welding, or the like, but is not limited thereto. In the first direction, the two placement tables 30 are disposed at two sides of the laminated body 40, respectively. The material suction assembly is connected to the moving block so that the material suction assembly may be driven to move when the moving block moves. The material suction assembly includes two suction structures. The two suction structures may be liftable in the height direction of the apparatus for preparing the electrode sheet to enable the suction structures to smoothly pick the dry-process electrode film of the electrode sheet. The two suction structures are arranged in the first direction. The two suction structures correspond to the two placement tables 30 in a one-to-one correspondence. Each of the two suction structures may be moved above a corresponding placement table of the two placement tables 30 along with the moving block and may be liftable through the suction structures to smoothly pick the dry-process electrode film.

In an exemplary embodiment of the present disclosure, in a thickness direction of the dry-process electrode film, the cut dry-process electrode film has a front side and a back side. The plurality of layers of dry-process electrode films are placed on one placement table 30 with the front sides facing up, and the plurality of layers of dry-process electrode films are placed on another placement table 30 with the front sides facing down. The suction structure is driven by the moving block to move above a corresponding placement table 30. The suction structure is lowered in the height direction of the apparatus for preparing the electrode sheet, to smoothly pick the dry-process electrode film with the front side facing up.

After the suction structure picks the dry-process electrode film, the suction structure is lifted in the height direction of the apparatus for preparing the electrode sheet, and moves to a position above the laminator body 40 by means of the moving block. Then, the suction structure is lowered in the height direction of the apparatus for preparing the electrode sheet to place the picked dry-process electrode film with the front side facing up on the laminator body 40. Another suction structure operates in the same principle, to allow the picked dry-process electrode film with the front side facing down to be placed on the laminator body 40. Therefore, the dry-process electrode films, which are oriented in opposite directions, placed on the two placement tables 30 can be alternately stacked on the laminator body 40.

The current collector is placed on a certain number of stacked dry-process electrode films, and the same number of dry-process electrode films oriented in opposite directions are continuously stacked on the current collector according to the same principle, to allow the plurality of layers of dry-process electrode films, the current collector, and the plurality of layers of dry-process electrode films to be stacked together in sequence. The plurality of layers of dry-process electrode films, the current collector, and the plurality of layers of dry-process electrode films, which are stacked together, are driven by the laminator body 40 to move to the position below the pressing head 41. The pressing head 41 presses the plurality of layers of dry-process electrode films, the current collector, and the plurality of layers of dry-process electrode films, which are stacked together, to form the electrode sheet.

Therefore, by disposing the two placement tables 30 at two sides of the laminator body 40, respectively, and placing the dry-process electrode films on the two placement tables 30 in opposite directions, the two suction structures may sequentially pick the dry-process electrode films on the corresponding placement tables 30, and the dry-process electrode films on the corresponding placement tables 30 may be stacked in sequence on the current collector. In this way, the plurality of layers of dry-process electrode films can be arranged in a manner that front and back sides of the plurality of layers of dry-process electrode films alternate with respect to the current collector, reducing the risk of the electrode sheet having the uneven thickness, and thus improving the flatness of the electrode sheet after lamination and molding. Also, the risk of defects such as burrs in the electrode sheet can be reduced. Therefore, the safety performance of the battery cell can be improved.

In some embodiments of the present disclosure, as illustrated in FIG. 3, in the first direction, the laminator body 40 is spaced from the two placement tables 30 by an equal distance.

In the first direction, the laminator body 40 is spaced the equal distance from each of the two placement tables 30. In other words, a spacing distance between the laminator body 40 and a placement table 30 at a side is L1, and a spacing distance between the laminator body 40 and a placement table 30 at another side is L2, where L1=L2. With such an arrangement, the two placement tables 30 can be reasonably arranged. It should be noted that a spacing distance between a center of the laminator body 40 and a center of each of the two placement tables 30 is equal to a spacing distance between centers of the two suction structures. In this way, when the two suction structures are lowered simultaneously, one suction structure picks a dry-process electrode film from one placement table 30, while another suction structure stacks a dry-process electrode film onto the laminator body 40, improving an operation efficiency of the apparatus for preparing the electrode sheet.

In some embodiments of the present disclosure, as illustrated in FIG. 3, the laminator body 40 is movably disposed at the fixation support 10 in the second direction.

As some embodiments of the present disclosure, the laminator body 40 may be disposed at the fixation support 10 through a slide rail. As some embodiments of the present disclosure, the laminator body 40 may be disposed at the fixation support 10 through the conveyor belt, to enable the laminator body 40 to be movable in the second direction, that is, the Y direction in FIG. 2. Therefore, the laminator body 40 can be moved to the position below the pressing head 41 or a position below the linear module 11 in the second direction, enabling the laminator body 40 to have both the functions of a stacking device and a pressing device, which reduces a risk of increasing a manufacturing cost of the apparatus for preparing the electrode sheet due to a separate design of the stacking device and the pressing device. Therefore, a low-cost design of the apparatus for preparing the electrode sheet can be facilitated.

In some embodiments of the present disclosure, as illustrated in FIG. 3, the material suction assembly may further include a first lifting drive structure 20 disposed at the moving block, and a fixation column 21 fixedly disposed at a lifting end of the first lifting drive structure 20. The two suction structures are fixedly disposed at the fixation column 21.

As some embodiments of the present disclosure, the first lifting drive structure 20 may be configured as a drive motor. As some embodiments of the present disclosure, the first lifting drive structure 20 may be configured to drive a cylinder. In the height direction of the apparatus for preparing the electrode sheet, the first lifting drive structure 20 has two opposite ends. One end of the first lifting drive structure 20 is disposed at the moving block, to enable the moving block to drive the first lifting drive structure 20 to move in the first direction. One end of the first lifting drive structure 20 away from the moving block is a lifting end. The fixation column 21 is fixedly disposed at the lifting end of the first lifting drive structure 20. The two suction structures may be fixed to the fixation column 21 through welding, bolting, etc., but are not limited thereto, to enable the lifting end of the first lifting drive structure 20 to drive the fixation column 21 to move the suction structures to be liftable in the height direction of the apparatus for preparing the electrode sheet. Therefore, moving the suction structures to a suitable height to smoothly pick the dry-process electrode film can be realized.

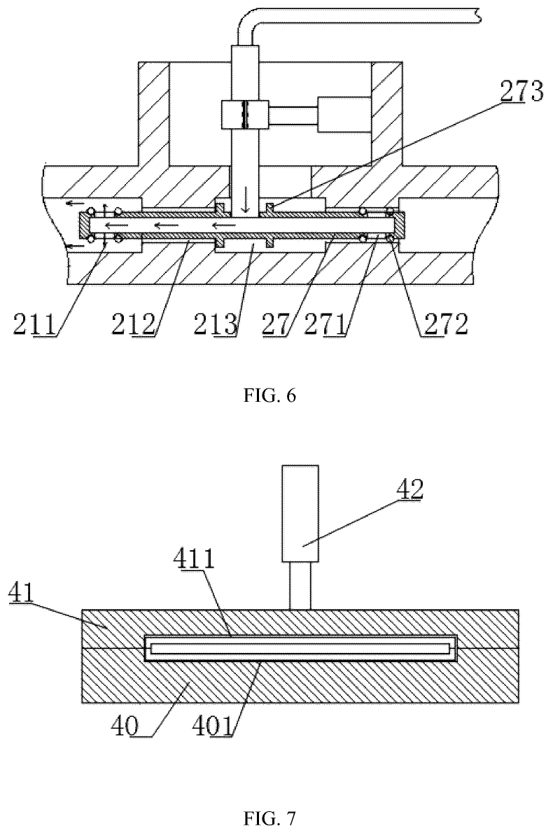

In some embodiments of the present disclosure, as illustrated in FIG. 6, the material suction assembly may further include a switching member 27. The fixation column 21 has two airflow channels 211 arranged in the first direction and spaced apart from each other. The two suction structures are each configured as a suction disk 26. The two suction structures are in communication with the two airflow channels 211, respectively. The switching member 27 is disposed in the fixation column 21 and located between the two airflow channels 211. The switching member 27 is controlled to be in communication with one of the two airflow channels 211 and disconnected from the other one of the two airflow channels 211 by moving the switching member 27 in the first direction, to control one of the two suction structures to pick the dry-process electrode film and the other one of the two suction structures to place the dry-process electrode film.

The fixation column 21 has two airflow channels 211 in the fixation column 21. In the first direction, the two airflow channels 211 are arranged close to two ends of the fixation column 21, respectively. In addition, the two airflow channels 211 are spaced apart from each other. The suction structure may be configured as the suction disk 26. The two airflow channels 211 correspond to two suction disks 26 in a one-to-one correspondence. The suction structure is in communication with the airflow channel 211 corresponding to the suction structure. The switching member 27 is disposed in the fixation column 21 and located between the two airflow channels 211, to enable the switching member 27 to be selectively in communication with one of the two airflow channels 211 and disconnected from the other one of the two airflow channels 211.

In an exemplary embodiment of the present disclosure, the switching member 27 may be in communication with the connection pipe 23. The connection pipe 23 may be in communication with a gas source. When the switching member 27 moves in the first direction towards one of the two airflow channels 211, the switching member 27 is in communication with the one of two airflow channels 211 and disconnected from the other one of the two airflow channels 211. When the switching member 27 moves in the first direction towards the other one of the two airflow channels 211, the switching member 27 is in communication with the other one of the two airflow channels 211 and disconnected from the one of the two airflow channels 211. By controlling the switching member 27 to be in communication with one of the two airflow channels 211 and to be disconnected from the other one of the two airflow channels 211, a suction structure in communication with the switching member 27 can be controlled to pick the dry-process electrode film and a suction structure disconnected from the switching member 27 can be controlled to place the dry-process electrode film, improving a stacking efficiency of the dry-process electrode film.

In some embodiments of the present disclosure, as illustrated in FIG. 5, the suction disk 26 has a plurality of exhaust holes 25. The suction disk 26 has a plurality of jet channels 28 formed at a suction end of the suction disk 26 and extending in a radial direction of the suction disk 26. The plurality of exhaust holes 25 correspond to the plurality of jet channels 28 in a one-to-one correspondence. In addition, each of the plurality of exhaust holes 25 is in communication with one of the plurality of jet channels 28 corresponding to the exhaust hole 25 and one of the two airflow channels 211 corresponding to the exhaust hole 25.

The plurality of exhaust holes 25 or the plurality of jet channels 28 may be uniformly arranged in a circumferential direction of the suction disk 26, to improve stability in a process of picking the dry-process electrode film and reduce a risk of failure of picking the dry-process electrode film caused by blockage of any one of the plurality of exhaust holes 25 or any one of the plurality of jet channels 28. The plurality of exhaust holes 25 correspond to the plurality of jet channels 28 in a one-to-one correspondence. That is, each of the plurality of exhaust holes 25 corresponds to one of the plurality of jet channels 28 corresponding to the exhaust hole. In addition, each of the plurality of exhaust holes 25 is in communication with one of the plurality of jet channels 28 corresponding to the exhaust hole 25 and one of the two airflow channels 211 corresponding to the exhaust hole 25.

When one of the two suction disks 26 is moved to a position above the placement table 30 corresponding to the one of the two suction disks 26, the switching member 27 moves in the first direction towards the suction disk 26, and the switching member 27 is in communication with the airflow channel 211. In this case, the switching member 27, the airflow channel 211, a corresponding exhaust hole 25, and a corresponding jet channel 28 are all in communication with one another to enable an airflow to flow between the switching member 27, the airflow channel 211, the corresponding exhaust hole 25, and corresponding jet channel 28. Therefore, the suction disk 26 can be facilitated to pick the dry-process electrode film.

The other one of the two suction disks 26 moves to a position above the laminator body 40. The switching member 27 is disconnected from the airflow channel 211 corresponding to the suction disk 26. In this case, an airflow between the switching member 27 and the airflow channel 211 is interrupted. No air flows through a corresponding exhaust hole 25 and a corresponding jet channel 28. The suction disk 26 no longer picks the dry-process electrode film. The dry-process electrode film falls into the laminator body 40 under the action of gravity. Therefore, an effect of one suction disk 26 picking the dry-process electrode film while the other suction disk 26 stacking a dry-process electrode film simultaneously can be realized, improving the stacking efficiency of the dry-process electrode film.

In some embodiments of the present disclosure, as illustrated in FIG. 6, the fixation column 21 has a connection channel formed therein, the connection channel is located between the two airflow channels 211 and in communication with the two airflow channels 211. The switching member 27 extends in the first direction and is partially disposed in the connection channel. The switching member 27 has a cavity formed therein and configured to convey an airflow. A side wall of the cavity has a communication hole 271 at a position close to each of two ends of the switching member 27 in the first direction, and the communication hole 271 is in communication with the cavity. By moving the switching member 27 in the first direction, the communication hole 271 at one of the two ends of the switching member 27 is located in the airflow channel 211, and the communication hole 271 at the other one of the two ends of the switching member 27 is located in the connection channel.

In the first direction, the connection channel is located between the two airflow channels 211, and the two airflow channels 211 are in communication with each other by the connection channel. The switching member 27 extends in the first direction and is partially disposed in the connection channel. The switching member 27 has the cavity configured to convey the airflow. The communication hole 271 in communication with the cavity is formed in the side wall of the cavity close to each of two ends of the switching member 27 in the first direction. The plurality of communication holes 271 are provided. The communication hole 271 may be in communication with the cavity and the corresponding airflow channel 211, to enable the airflow to flow between the switching member 27 and the corresponding the airflow channel 211.

By moving the switching member 27 in the first direction, the communication hole 271 at one of the two ends of the switching member 27 is located in the airflow channel 211, and the communication hole 271 at the other one of the two ends of the switching member 27 is located in the connection channel. In this way, the communication hole 271 located in the airflow channel 211 can be in communication with the cavity and the corresponding airflow channel 211, and the communication hole 271 located in the connection channel cannot be in communication with the corresponding airflow channel 211, to disconnect the cavity from the corresponding airflow channel 211. In this case, the airflow flows between a cavity in the airflow channel 211 at a side of the communication hole 271, the airflow channel 211, the exhaust hole 25, and the jet channel 28, enabling the corresponding suction disk 26 to pick the dry-process electrode film.

The airflow is disconnected between the cavity in the connection channel at the side of the communication hole 271 and the airflow channel 211, to enable the corresponding suction disk 26 no longer to pick the dry-process electrode film. The dry-process electrode film falls into the laminator body 40 under the action of gravity, realizing the effect of one suction disk 26 picking the dry-process electrode film while the other suction disk 26 stacking the dry-process electrode film.

In some embodiments of the present disclosure, as illustrated in FIG. 5, the material suction assembly may further include a connection pipe 23 connected to the switching member 27 and in communication with the cavity.

The connection pipe 23 is connected to the switching member 27 and in communication with the cavity, to enable an airflow in the connection pipe 23 to be continuously delivered to the cavity, facilitating the two suction disks 26 to be connected to the connection pipe 23 in sequence. Therefore, one suction disk 26 can stack the dry-process electrode film while the other suction disk 26 can pick the dry-process electrode film, which can further improve the stacking efficiency of the dry-process electrode film.

In some embodiments of the present disclosure, as illustrated in FIG. 5, the material suction assembly may further include a drive member 24. The connection pipe 23 extends through the fixation column 21 into the connection channel. The connection pipe 23 is fixedly connected to the switching member 27. The drive member 24 is fixedly disposed at the fixation column 21 and connected to the connection pipe 23. The drive member 24 is configured to drive the connection pipe 23 to move in the first direction to move the switching member 27.

In the height direction of the apparatus for preparing the electrode sheet, the connection pipe 23 may extend through an upper side wall of the fixation column 21. The connection pipe 23 may extend into the connection channel. As some embodiments of the present disclosure, the connection pipe 23 is connected to the switching member 27 through welding. As some embodiments of the present disclosure, the connection pipe 23 is connected to the switching member 27 by bolts. The drive member 24 may be, but not limited to, configured as a drive motor or a drive cylinder, or the like. The drive member 24 may be fixed to the fixation column 21 through bolting, welding, or the like, but is not limited thereto. In addition, the drive member 24 is connected to the connection pipe 23 at a drive end of the drive member 24, to enable the drive end of the drive member 24 to drive the connection pipe 23 to move in the first direction. The connection pipe 23 drives the switching member 27 to move in the first direction, to realize an effect of indirectly driving the switching member 27 to move in the first direction. Therefore, an effect of controlling connection or disconnection between the cavity of the switching member 27 and the corresponding airflow channel 211 can be realized.

In some embodiments of the present disclosure, as illustrated in FIG. 5, the fixation column 21 is provided with an extension structure 22 formed at an outer peripheral wall of the fixation column 21 and protruding from the fixation column 21. The drive member 24 is fixedly disposed at the extension structure 22.

The fixation column 21 is provided with the extension structure 22. The extension structure 22 may be annular. The extension structure 22 is formed at the outer peripheral wall of the fixation column 21 and protrudes from the fixation column 21. In this way, the extension structure 22 can be disposed outside the airflow channel 211 and the connection channel of the fixation column 21, reducing a risk of the drive member 24 interfering with airflow circulation. In addition, the extension structure 22 can provide an assembly position for the drive member 24. The drive member 24 can be fixedly disposed at the extension structure 22. Further, the drive member 24 is fixedly disposed in the extension structure 22, which can reduce interference from an external environment on the drive member 24, facilitate improving operational stability of the drive member 24, and thus prolong a service life of the drive member 24.

In some embodiments of the present disclosure, as illustrated in FIG. 6, the connection channel includes a moving channel 213 and two communication channels 212. The moving channel 213 is located between the two communication channels 212 and in communication with the two communication channels 212. The two communication channels 212 are arranged in the first direction and located between the two airflow channels 211. The moving channel 213 has a greater cross-section than each of the two communication channels 212. The switching member 27 is provided with two limit rings 273 at an outer peripheral wall of the switching member 27. The two limit rings 273 are located in the moving channel 213 and arranged in the first direction.

In the first direction, the two communication channels 212 are located at two ends of the connection channel, respectively. In addition, the moving channel 213 is located between the two communication channels 212. That is, the communication channel 212, the moving channel 213, and the communication channel 212 are sequentially arranged in the first direction. The moving channel 213 is in communication with the two communication channels 212. The two communication channels 212 are arranged in the first direction and located between the two airflow channels 211. That is, the airflow channel 211, the communication channel 212, the moving channel 213, the communication channel 212, and the airflow channel 211 are arranged in sequence in the first direction.

The moving channel 213 has a greater cross-section than each of the two communication channels 212, to enable a limit boss to be formed between the moving channel 213 and each of the communication channels 212 at two sides of the moving channel 213. The switching member 27 is provided with two limit rings 273 at the outer peripheral wall of the switching member 27. The two limit rings 273 may be fixedly disposed at the outer peripheral wall of the switching member 27 through welding or the like, but not limited to welding. The two limit rings 273 are located in the moving channel 213 and arranged in the first direction. When the switching member 27 moves in the first direction, the two limit rings 273 may abut with the corresponding limit bosses, to restrict excessive movement of the switching member 27. In this way, when the drive member 24 drives the connection pipe 23, a risk of damage of the connection pipe 23 due to impact with the outer peripheral wall of the fixation column 21 is reduced. Therefore, a risk of failure of the material suction assembly is lowered, which is beneficial for prolonging a service life of the apparatus for preparing the electrode sheet.

In some embodiments of the present disclosure, as illustrated in FIG. 6, the switching member 27 is sleeved with a sealing ring 272. In addition, the sealing ring 272 is disposed on each of two sides of the communication hole 271 in the first direction. The sealing ring 272 is adapted to abut with an inner wall of the connection channel.

As some embodiments of the present disclosure, the sealing ring 272 may be made of a rubber material. As some embodiments of the present disclosure, the sealing ring 272 may be made of a felt material. A plurality of sealing rings 272 may be provided and sleeved at the outer peripheral wall of the switching member 27. In the first direction, the sealing ring 272 is disposed on each of two sides of each communication hole 271. When the switching member 27 moves in the first direction, the communication hole 271 at a side and the sealing rings 272 at two sides of the communication hole 271 are all moved into the airflow channel 211. The sealing rings 272 are separated from an inner wall of the connection channel. The communication hole 271 enables the cavity to be in communication with the corresponding airflow channel 211, to allow the suction disk 26 on this side to pick the dry-process electrode film.

The communication hole 271 at the other side and the sealing rings 272 at two sides of the communication hole 271 are all moved into the communication channel 212. The sealing rings 272 abut with the inner wall of the connection channel. The suction disk 26 on this side no longer picks the dry-process electrode film. The dry-process electrode film falls into the laminator body 40 under the action of gravity, achieving the stacking effect of the dry-process electrode film. By disposing the sealing rings 272, a gap between the cavity and the corresponding airflow channel 211 can be reliably sealed, reducing a risk of a suction or stacking failure of the dry-process electrode film due to air leakage, and thus improving operational stability of the apparatus for preparing the electrode sheet.

In some embodiments of the present disclosure, as illustrated in FIG. 7, the apparatus for preparing the electrode sheet may further include a second lifting drive structure 42 connected between the pressing head 41 and the top wall of the fixation support 10.

As some embodiments of the present disclosure, the second lifting drive structure 42 may be configured as the drive motor. As some embodiments of the present disclosure, the second lifting drive structure 42 may be configured as the drive cylinder. The second lifting drive structure 42 is connected between the pressing head 41 and the top wall of the fixation support 10. Further, in the height direction of the apparatus for preparing the electrode sheet, the second lifting drive structure 42 may have two opposite ends. An output end of the second lifting drive structure 42 is connected to the pressing head 41 to control lifting of the pressing head 41 along the apparatus for preparing the electrode sheet. Therefore, the pressing head 41 can press the current collector and the dry-process electrode film that are stacked together to form the electrode sheet. A side of the second lifting drive structure 42 away from the output end may be fixedly connected to the top wall of the fixation support 10 through welding, bolting, or the like, but is not limited thereto, to improve operational stability of the second lifting drive structure 42, which is beneficial for the second lifting drive structure 42 to reliably drive the pressing head 41 and achieve an effect of smoothly pressing the electrode sheet.

In some embodiments of the present disclosure, as illustrated in FIG. 3, the fixation support 10 is provided with a moving track 12 fixedly disposed at the bottom wall of the fixation support 10. The laminator body 40 is movably disposed at the moving track 12.

The fixation support 10 is provided with the moving track 12. The moving track 12 is disposed at the bottom wall of the fixation support 10 in the height direction of the apparatus for preparing the electrode sheet. The moving track 12 extends in the second direction. The laminator body 40 is movably disposed at the moving track 12, to enable the laminator body 40 to selectively move to the position below the pressing head 41 or the position below the linear module 11 in the second direction. When the dry-process electrode film and the current collector need to be stacked in the laminator body 40, the laminator body 40 moves to the position below the linear module 11 in the second direction, such that the plurality of layers of dry-process electrode films, the current collector, and the plurality of layers of dry-process electrode films are stacked in sequence. The laminator body 40, via the moving track 12, drives the plurality of layers of dry-process electrode films, the current collector, and the plurality of layers of dry-process electrode films, that are stacked together, to move in the second direction to the position below the pressing head 41. The pressing head 41 is lowered under the action of the second lifting drive structure 42 to press the electrode sheet. After the electrode sheet is pressed, the laminator body 40, via the moving track 12, continues to move in the second direction to the position below the linear module 11 for stacking again. This process repeats cyclically, achieving an effect of continuous processing of electrode sheets.

In some embodiments of the present disclosure, as illustrated in FIG. 7 and FIG. 8, the laminator body 40 has a first groove 401 formed at an upper end surface of the laminator body 40. The pressing head 41 has a second groove 411 formed at a lower end surface of the pressing head 41 and corresponding to the first groove 401. The pressing head 41 is driven to move downwardly to allow edges of dry-process electrode films at two sides of a current collector of the electrode sheet to abut with each other.

The laminator body 40 has the first groove 401 formed at the upper end surface of the laminator body 40. In addition, the first groove 401 is recessed towards an interior of the laminator body 40. The dry-process electrode film and the current collector are stacked in the first groove 401, which is beneficial to improving accurate positioning of stacking. The pressing head 41 has the second groove 411 corresponding to the first groove 401 at the lower end surface of the pressing head 41. A size and a shape of the first groove 401 are adapted to those of the second groove 411. When the second lifting drive structure 42 drives the pressing head 41 to move downwardly, the current collector is disposed in a space between the first groove 401 and the second groove 411, reducing a risk that the pressing head 41 crushes the electrode sheet. The size of the dry-process electrode film may be greater than the size of the current collector, to allow outer edges of dry-process electrode films at two sides of the current collector to abut with each other under a pressing action of the pressing head 41. The size of the dry-process electrode film may be equal to the size of the current collector, to allow outer edges of dry-process electrode films at two sides of the current collector to extend and then abut with each other under the pressing action of the pressing head 41. Therefore, the dry-process electrode film can wrap the current collector, reducing the risk of defects such as burrs in the electrode sheet. Therefore, the safety performance of the battery cell can be improved.

In some embodiments of the present disclosure, as illustrated in FIG. 8, the laminator body 40 further has an electrode tab-receiving groove 402 formed at the upper end surface of the laminator body 40. The electrode tab-receiving groove 402 abuts with the first groove 401 and is in communication with the first groove 401.

The laminator body 40 further has the electrode tab-receiving groove 402 formed at the upper end surface of the laminator body 40. The electrode tab-receiving groove 402 abuts with the first groove 401. Therefore, when the current collector is placed in the first groove 401, the electrode tab-receiving groove 402 can receive an electrode tab of the current collector, to reduce a risk of damage to the current collector caused by interference between the electrode tab and a side wall of the first groove 401. Further, two electrode tab-receiving grooves 402 may be provided. Since the electrode tab is disposed close to one end of the current collector, by disposing the two electrode tab-receiving grooves 402, the current collector can be smoothly placed in the laminator body 40 regardless of whether the current collector is placed forward or backward, which is beneficial to improving a use efficiency of the laminator body 40.

As illustrated in FIG. 9, the electrode sheet according to the embodiment of the present disclosure is prepared based on the method for preparing the electrode sheet according to the above embodiments. The electrode sheet may include a current collector and a plurality of layers of dry-process electrode films. The current collector and the plurality of layers of dry-process electrode films are stacked together. The current collector has a first side and a second side opposite to the first side. The plurality of layers of dry-process electrode films are disposed on each of the first side and the second side. The plurality of layers of dry-process electrode films on a same side of the current collector are arranged in a manner that front and back sides of the plurality of layers of dry-process electrode films alternate with respect to the current collector.

The current collector and the plurality of layers of dry-process electrode films are stacked together. In the thickness direction of the current collector, the current collector has the first side and the second side opposite to the first side. The plurality of layers of dry-process electrode films are disposed on each of the first side and the second side. In addition, the plurality of layers of dry-process electrode films on the same side of the current collector are arranged in a manner that front and back sides of the plurality of layers of dry-process electrode films alternate with respect to the current collector, reducing the risk of the electrode sheet having the uneven thickness, and thus improving the flatness of the electrode sheet after lamination and molding. Also, the risk of defects such as burrs in the electrode sheet can be reduced. Therefore, the safety performance of the battery cell can be improved.

A battery cell is provided according to the embodiment of the present disclosure. The battery cell includes the electrode sheet according to the above embodiments. By disposing the two placement tables 30 at two sides of the laminator body 40, respectively, and placing the dry-process electrode films on the two placement tables 30 in opposite directions, the two suction structures may sequentially pick the dry-process electrode films on the corresponding placement tables 30, and the dry-process electrode films on the corresponding placement tables 30 may be stacked in sequence on the current collector. In this way, the plurality of layers of dry-process electrode films can be arranged in a manner that front and back sides of the plurality of layers of dry-process electrode films alternate with respect to the current collector, reducing the risk of the electrode sheet having the uneven thickness, and thus improving the flatness of the electrode sheet after lamination and molding. Also, the risk of defects such as burrs in the electrode sheet can be reduced. Therefore, the safety performance of the battery cell can be improved.

A battery device is provided according to the embodiment of the present disclosure. The battery device includes the battery cell according to the above embodiments. By disposing the two placement tables 30 at two sides of the laminator body 40, respectively, and placing the dry-process electrode films on the two placement tables 30 in opposite directions, the two suction structures may sequentially pick the dry-process electrode films on the corresponding placement tables 30, and the dry-process electrode films on the corresponding placement tables 30 may be stacked in sequence on the current collector. In this way, the plurality of layers of dry-process electrode films can be arranged in a manner that front and back sides of the plurality of layers of dry-process electrode films alternate with respect to the current collector, reducing the risk of the electrode sheet having the uneven thickness, and thus improving the flatness of the electrode sheet after lamination and molding. Also, the risk of defects such as burrs in the electrode sheet can be reduced. Therefore, the safety performance of the battery cell can be improved, further improving safety performance of the battery device.

### First Embodiment

The method for preparing the electrode sheet further includes: putting a first electrode film layer, the current collector, and a second electrode film layer into a laminator in sequence, and performing pressing and molding on the first electrode film layer, the current collector, and the second electrode film layer, to enable the first electrode film layer and the second electrode film layer at two sides of the current collector to wrap an edge of the current collector to obtain a dry-process positive electrode sheet/a dry-process negative electrode sheet; and stacking m layers of dry-process electrode films in a manner that front and back sides of the m layers of dry-process electrode films alternate to obtain the first electrode film layer, stacking n layers of dry-process electrode films in a manner that front and back sides of the n layers of dry-process electrode films alternate to obtain the second electrode film layer. The size of the current collector is not greater than that of the dry-process electrode film, where m≥2, n≥2, both m and n being integers.

The dry-process electrode films located at the same side of the current collector are sequentially arranged in a manner that front and back sides of the dry-process electrode films alternate, which can eliminate a phenomenon of the uneven thickness of the electrode film in a rolling process, enabling the upper end face or the lower end face of the electrode sheet to be located at the same horizontal plane without obvious depression, bulging, etc. In this way, the safety performance of the electrode sheet may be improved. The size of the electrode film is greater than or equal to that of the current collector. During laminating, as illustrated in FIG. 7, the first electrode film layer or the second electrode film layer may uniformly deform and extend towards the edge to wrap the cut edge of the current collector, which can eliminate the influence of burrs. Also, stacking the electrode films in a manner that front and back sides of the electrode films alternate can effectively eliminate uneven deformation and extension due to local areas being too thick or too thin during stacking the electrode films with only front sides or back sides facing up, which may lead to a failure of wrapping the cut edge of the current collector. If m/n, in the corresponding negative or positive electrode sheet, m/n. If m=n, in the corresponding negative or positive electrode sheet, m=n. The current collector is made of the aluminum foil or the copper foil.

### Second Embodiment

The apparatus for preparing the electrode sheet include the fixation support 10, the laminator, the placement table 30, and the material suction assembly. The fixation support 10 is provided with the linear module 11 at the top of the fixation support 10. The linear module 11 having a moving block movable linearly. The laminator is disposed in the fixation support 10. The laminator includes a laminator body 40 disposed at the bottom of the fixation support 10 and the pressing head 41 disposed at the top wall of the fixation support 10 and away from an end of the linear module 11. The placement table 30 is disposed in the fixation support 10 and located at two sides of the laminator body 40. The material suction assembly includes the first lifting drive structure 20 disposed at the moving block and the fixation column 21 disposed at a lifting end of the first lifting drive structure 20. The airflow channels 211 are formed at two sides of the fixation column 21. The suction disks 26 in communication with the corresponding airflow channels 211 are provided at two sides of a bottom of the fixation column 21. The switching member is disposed between the two airflow channels 211. By driving the switching member to move, connection or disconnection between the switching member and the airflow channels 211 is controlled, controlling one of the two suction disks 26 to pick the electrode film and the other one of the two suction disks 26 to place the electrode film.

In an exemplary embodiment of the present disclosure, the cut electrode film with the front side facing up is placed at one of the two placement tables 30, and the electrode film with the front side facing down is placed at the other one of the two placement tables 30. By using the material suction assembly, the electrode films on the two placement tables 30 may be alternately stacked at the laminator body 40. First, with cooperation of the linear module 11, one of the suction disks 26 is located directly above the placement table 30, while the other one of suction disks 26 is located directly above the laminator body 40. The first lifting drive structure 20 pushes the fixation column 21 to move downwardly. When the electrode film on the placement table 30 needs to be picked and the electrode film located on the laminator body 40 needs to be placed, the switching member moves to be disconnected from the airflow channel 211 above the laminator body 40, causing the electrode film picked on the lower end surface of the suction disk 26 in communication with the airflow channel 211 to release. Also, the switching member is in communication with the other one of airflow channels 211, picking the electrode film from the placement table 30. In this case, the first lifting drive structure 20 pushes the fixation column 21 to move upwardly. Then, the linear module drives the fixation column 21 to move, in such a manner that the suction disk 26 without an electrode film moves to the other placement table 30, while the suction disk 26 with a picked electrode film moves to be directly above the laminator body 40. By repeating the above operations, the electrode films on the two placement tables 30 can be alternately stacked, allowing the electrode films from the two placement tables 30 to be arranged in a manner that front and back sides of the electrode films alternate. Stacking the electrode films in a manner that front and back sides of the electrode films alternate can eliminate a problem of an uneven thickness of the electrode sheet caused by an uneven thickness of the electrode film in the rolling process. Then, the cut current collector is placed on the plurality of layers of dry-process electrode films, and then the material suction assembly is used to stack the plurality of layers of dry-process electrode films, in a manner that front and back sides of the plurality of layers of dry-process electrode films alternate, on the current collector, which are then pressed and formed through cooperation between the laminator body 40 and the pressing head 41.

To reduce damage to a surface of the electrode film during suction of the suction disk 26, as illustrated in FIG. 3, FIG. 5, and FIG. 6, the suction disk 26 has a plurality of exhaust holes 25 in communication with the suction disk 26. The suction disk 26 has the plurality of jet channels 28 formed at a bottom end face of the suction disk 26. The plurality of exhaust holes 25 correspond to the plurality of jet channels 28 in a one-to-one correspondence. In an exemplary embodiment of the present disclosure, when the electrode film on the placement table 30 needs to be picked and the electrode film located at the laminator body 40 needs to be placed, the switching member moves to be disconnected from the airflow channel 211 above the laminator body 40. The airflow channel 211 has already a high-pressure gas exhaust channel. The jet channel 28 is in communication with the external environment, causing the electrode film picked on a lower end surface of the suction disk 26 in communication with the airflow channel 211 to release. Also, the switching member is in communication with the other one of airflow channels 211, forming the high-pressure gas exhaust channel. A high-pressure gas in the suction disk 26 flows through the exhaust hole 25 into the jet channel 28, forming a high-speed jet, which then is discharged from an outer edge of a bottom surface of the suction disk 26, carrying away air beneath the suction disk 26 and creating a negative pressure zone. Therefore, the electrode film on the placement table 30 is picked. A suction force is generated through air flow, rather than directly applying a high pressure, a low pressure, or using vacuum, which can better protect the surface of the electrode film from surface damage. The switching member is in communication with an air compressor.

In one embodiment, as illustrated in FIG. 6, the switching member includes a switching member 27 movably disposed in the fixation column 21. The switching member 27 has the cavity configured to convey the airflow. Two ends of the switching member 27 extend into the corresponding airflow channels 211. Communication holes 271 are formed in a side wall of the switching member 27 close to two ends of the switching member 27. The moving channel 213 is disposed in the fixation column 21 and located at a middle position. The connection pipe 23 is disposed at a top of the switching member 27 and located in the moving channel 213. The extension structure 22 is disposed at a center of a top of the fixation column 21 and extends upwardly. The connection pipe 23 extends through the side wall of the fixation column 21 at a top of the connection pipe 23 into the extension structure 22. The drive member 24 is disposed at a side wall of the extension structure 22. The drive member 24 has a telescopic end detachably connected to the connection pipe 23. The communication channel 212 is disposed in the fixation column 21 and located between the moving channel 213 and the airflow channel 211. The drive member 24 pushes the switching member 27 to move, in such a manner that a communication hole 271 at an end of the switching member 27 is located in the airflow channel 211 and a communication hole 271 at another end of the switching member 27 is located in the communication channel 212. In an exemplary embodiment of the present disclosure, the drive member 24 pushes the switching member 27 to move, causing the communication hole 271 at the end of the switching member 27 to enter the airflow channel 211, and thus forming a complete high-pressure gas exhaust channel between the airflow channel 211 and the switching member. In this way, the electrode film may be picked. Also, the communication hole 271 at the other end of the switching member 27 moves into the communication channel 212 and is disconnected from the corresponding airflow channel 211. Therefore, the suction disk 26 corresponding to the airflow channel can be disconnected from the electrode film, allowing the electrode film to be stacked on the laminator body 40.

To prevent the communication hole 271 entering the communication channel 212 from affecting an airflow pressure in the switching member 27, as illustrated in FIG. 3 and FIG. 4, the sealing ring 272 is embedded at a surface of the switching member 27 and located on each of two sides of the communication hole 271. Two limit rings 273 are disposed at a circumferential surface of the switching member 27 and located in the moving channel 213. The limit ring 273 has a diameter greater than a diameter of the communication channel 212. The moving channel 213 has a diameter greater than the diameter of the limit ring 273. Two sealing rings 272 have a sealing region around the communication hole 271 through cooperation with an inner wall of the communication channel 212 without pressure leakage, which can ensure that normal operation of the other communication hole 271 is not affected. In addition, the limit ring 273 may seal the communication channel 212 that forms the high-pressure gas exhaust channel, effectively preventing the pressure leakage.

In one embodiment, as illustrated in FIG. 7 and FIG. 8, the second lifting drive structure 42 is fixedly disposed between the pressing head 41 and the fixation support 10. The laminator body 40 has the first groove 401 formed at the upper end surface of the laminator body 40. The pressing head 41 has the second groove 411 formed at the lower end surface of the pressing head 41. The pressing head 41 is driven to move downwardly, controlling edges of the electrode films on an upper end surface and a lower end surface of the current collector to be wrapped around two sides of the current collector. In an exemplary embodiment of the present disclosure, an electrode sheet including the first electrode film layer, the current collector, and the second electrode film layer is formed at the laminator body 40. The laminator body 40 is driven to move to a position directly below the pressing head 41. The pressing head 41 is driven to move downwardly to press to form the dry-process positive electrode sheet/the dry-process negative electrode sheet. During pressing, the second groove 411 on the pressing head 41 may press an edge of the first electrode film layer on the upper end surface of the current collector, causing the edge to wrap around two cut sides of the current collector. Similarly, when the pressing head 41 moves downwardly, an edge of the second electrode film layer on the lower end surface of the current collector is pushed towards the current collector through cooperation with the first groove 401, causing the edge to wrap around two cut sides of the current collector. The electrode film may cover edges of the current collector, eliminating the influence of burrs. The pressing head 41 is heated to a temperature ranging from 100° C. to 300° C., with a pressure ranging from 0.1 MPa to 500 MPa, and a pressure-holding duration ranging from 0.1 minutes to 10 minutes. A width of each of the first groove 401 and the second groove 411 is greater than a width of the current collector. A width of the electrode film is greater than the width of each of the first groove 401 and the second groove 411.

To move the laminator body 40, as illustrated in FIG. 3, FIG. 5, and FIG. 7, the moving track 12 is disposed at the bottom of the fixation support 10. The laminator body 40 is disposed at the moving track 12. When the electrode film needs to be stacked in the laminator body 40, the laminator body 40 moves to a center position between the two placement tables 30. When the electrode sheets are stacked, the laminator body 40 moves to the position below the pressing head 41 for pressing.

In one embodiment, as illustrated in FIG. 7 and FIG. 8, two electrode tab-receiving grooves 402 are disposed at the upper end surface of the laminator body 40 and located at one end of the first groove 401. During the process of pressing into a cell, electrode tabs of different electrode sheets are pressed and bonded together more firmly due to an intermolecular bonding force, which can reduce occurrence of cold weld.

### Third Embodiment

The electrode sheet is prepared based on the method for preparing the electrode sheet according to the first embodiment.

### Fourth Embodiment

A high power soft pack lithium ion battery includes the electrode sheet according to the third embodiment.

The negative dry-process electrode sheet, a separator, and the positive dry-process electrode sheet are stacked in sequence by L times, where L≥1 and L is an integer, and the resulting stack is placed into the laminator body 40 and subjected to the temperature ranging from 100° C. to 300° C., the pressure ranging from 0.1 MPa to 500 MPa, and the pressure-holding duration ranging from 0.1 minutes to 10 minutes to obtain the cell, which is subsequently fabricated into a battery. Since the laminator body 40 has the electrode tab-receiving groove 402, when electrode tabs of different electrode sheets are pressed and bonded together more firmly due to an intermolecular bonding force, occurrence of cold weld can be reduced.

Reference throughout this specification to “an embodiment,” “some embodiments,” “illustrative embodiments,” “an example,” “a specific example,” or “some examples” means that a particular feature, structure, material, or characteristic described in connection with the embodiment or example is included in at least one embodiment or example of the present disclosure. The appearances of the above phrases in various places throughout this specification are not necessarily referring to the same embodiment or example. In addition, the particular features, structures, materials, or characteristics described may be combined in any suitable manner in any one or more embodiments or examples.

Although embodiments of the present disclosure have been illustrated and described, it is conceivable for those skilled in the art that various changes, modifications, replacements, and variations can be made to these embodiments without departing from the principles and spirit of the present disclosure. The scope of the present disclosure shall be defined by the claims as appended and their equivalents.

What is claimed is:

1. A method for preparing an electrode sheet, comprising:
cutting a dry-process electrode film material to form a dry-process electrode film;
cutting a current collector material to form a current collector, wherein a size of the current collector is smaller than or equal to that of the dry-process electrode film; and
sequentially stacking and pressing a plurality of layers of dry-process electrode films, the current collector, and a plurality of layers of dry-process electrode films to form the electrode sheet, wherein the plurality of layers of dry-process electrode films on a same side of the current collector are arranged in a manner that front and back sides of the plurality of layers of dry-process electrode films alternate with respect to the current collector.

2. The method for preparing an electrode sheet according to claim 1, wherein the current collector is provided with an electrode tab.

3. An apparatus for preparing an electrode sheet, comprising:
a fixation support provided with a linear module at a top wall of the fixation support, the linear module having a moving block movable in a first direction;
a laminator disposed in the fixation support, wherein the laminator comprises a laminator body movably disposed at a bottom wall of the fixation support and a pressing head disposed at the top wall of the fixation support, the pressing head being located at a side of the linear module in a second direction, the laminator body being selectively movable to a position below the pressing head, wherein the first direction, the second direction, and a height direction of the apparatus for preparing the electrode sheet are mutually perpendicular;
two placement tables disposed in the fixation support and at the bottom wall of the fixation support in the first direction, the two placement tables being disposed at two sides of the laminator body, respectively; and
a material suction assembly connected to the moving block, wherein the material suction assembly is driven to move with a movement of the moving block, and wherein the material suction assembly comprises two suction structures arranged in the first direction and configured to selectively pick the dry-process electrode film of the electrode sheet, the two suction structures being liftable in the height direction of the apparatus for preparing the electrode sheet.

4. The apparatus for preparing an electrode sheet according to claim 3, wherein, in the first direction, the laminator body is spaced from the two placement tables by an equal distance.

5. The apparatus for preparing an electrode sheet according to claim 3, wherein the laminator body is movably disposed at the fixation support in the second direction.

6. The apparatus for preparing an electrode sheet according to claim 3, wherein the material suction assembly further comprises:
a first lifting drive structure disposed at the moving block; and
a fixation column fixedly disposed at a lifting end of the first lifting drive structure, the two suction structures being fixedly disposed at the fixation column.

7. The apparatus for preparing an electrode sheet according to claim 6, wherein:
the material suction assembly further comprises a switching member;
the fixation column has two airflow channels arranged in the first direction and spaced apart from each other;
the two suction structures are each configured as a suction disk;
the two suction structures are in communication with the two airflow channels, respectively;
the switching member is disposed in the fixation column and located between the two airflow channels; and
the switching member is controlled to be in communication with one of the two airflow channels and disconnected from the other one of the two airflow channels by moving the switching member in the first direction, to control one of the two suction structures to pick the dry-process electrode film and the other one of the two suction structures to place the dry-process electrode film.

8. The apparatus for preparing an electrode sheet according to claim 7, wherein the suction disk has a plurality of exhaust holes, and wherein the suction disk has a plurality of jet channels formed at a suction end of the suction disk and extending in a radial direction of the suction disk, wherein:
the plurality of exhaust holes correspond to the plurality of jet channels in a one-to-one correspondence; and
each of the plurality of exhaust holes is in communication with one of the plurality of jet channels corresponding to the exhaust hole and one of the two airflow channels corresponding to the exhaust hole.

9. The apparatus for preparing an electrode sheet according to claim 8, wherein:
the fixation column has a connection channel formed therein, the connection channel being located between the two airflow channels and in communication with the two airflow channels;
the switching member extends in the first direction and is partially disposed in the connection channel, the switching member having a cavity formed therein and configured to convey an airflow, wherein a side wall of the cavity has a communication hole at a position close to each of two ends of the switching member in the first direction, the communication hole being in communication with the cavity; and
by moving the switching member in the first direction, the communication hole at one of the two ends of the switching member is located in the airflow channel, and the communication hole at the other one of the two ends of the switching member is located in the connection channel.

10. The apparatus for preparing an electrode sheet according to claim 9, wherein the material suction assembly further comprises a connection pipe connected to the switching member and in communication with the cavity.

11. The apparatus for preparing an electrode sheet according to claim 10, wherein:
the material suction assembly further comprises a drive member;
the connection pipe extends through the fixation column into the connection channel, the connection pipe being fixedly connected to the switching member;
the drive member is fixedly disposed at the fixation column and connected to the connection pipe; and
the drive member is configured to drive the connection pipe to move in the first direction to move the switching member.

12. The apparatus for preparing an electrode sheet according to claim 11, wherein the fixation column is provided with an extension structure formed at an outer peripheral wall of the fixation column and protruding from the fixation column, the drive member being fixedly disposed at the extension structure.

13. The apparatus for preparing an electrode sheet according to claim 9, wherein the connection channel comprises a moving channel and two communication channels, wherein:
the moving channel is located between the two communication channels and in communication with the two communication channels;
the two communication channels are arranged in the first direction and located between the two airflow channels;
the moving channel has a greater cross-section than each of the two communication channels; and
the switching member is provided with two limit rings at an outer peripheral wall of the switching member, the two limit rings being located in the moving channel and arranged in the first direction.

14. The apparatus for preparing an electrode sheet according to claim 9, wherein the switching member is sleeved with a sealing ring, the sealing ring being disposed on each of two sides of the communication hole in the first direction, and the sealing ring being adapted to abut with an inner wall of the connection channel.

15. The apparatus for preparing an electrode sheet according to claim 3, further comprising a second lifting drive structure connected between the pressing head and the top wall of the fixation support.

16. The apparatus for preparing an electrode sheet according to claim 3, wherein the fixation support is provided with a moving track fixedly disposed at the bottom wall of the fixation support, the laminator body being movably disposed at the moving track.

17. The apparatus for preparing an electrode sheet according to claim 3, wherein:
the laminator body has a first groove formed at an upper end surface of the laminator body;
the pressing head has a second groove formed at a lower end surface of the pressing head and corresponding to the first groove; and
the pressing head is driven to move downwardly to allow edges of dry-process electrode films at two sides of a current collector of the electrode sheet to abut with each other.

18. The apparatus for preparing an electrode sheet according to claim 17, wherein the laminator body further has an electrode tab-receiving groove formed at the upper end surface of the laminator body, the electrode tab-receiving groove abutting with the first groove and being in communication with the first groove.

19. An electrode sheet prepared by the method for preparing an electrode sheet according to claim 1, the electrode sheet comprising:
a current collector; and
a plurality of layers of dry-process electrode films, wherein:
the current collector and the plurality of layers of dry-process electrode films are stacked together; and
the current collector has a first side and a second side opposite to the first side, the plurality of layers of dry-process electrode films being disposed on each of the first side and the second side, and the plurality of layers of dry-process electrode films on a same side of the current collector being arranged in a manner that front and back sides of the plurality of layers of dry-process electrode films alternate with respect to the current collector.

20. A battery cell, comprising the electrode sheet according to claim 19.
